(19) United States
(12) Patent Application Publication
(10) Pub. No.: US 2008/0022157 A1
(43) Pub. Date: Jan. 24, 2008

(54) 'ISOLATING A TAPE DRIVE FROM COMMUNICATION'

(76) Inventors: Shannon Hsinhen Chang, Vail, AZ (US); Khanh Vi Ngo, Tucson, AZ (US); Corinna Joy Sheret, Sahuarita, AZ (US)

Correspondence Address: INTERNATIONAL BUSINESS MACHINES CORPORATION, 9000 SOUTH RITA ROAD, TUCSON, AZ, 85744, US

(21) Appl. No.: 11/459,623

(22) Filed: Jul. 24, 2006

(51) Int. Cl. G06F 11/00

(52) U.S. Cl. 714/42

(57) ABSTRACT

Disclosed are a method, a system, a computer program product for fencing a tape drive such that the fence is understood by all hosts that are connected to the tape drive. The tape drive is coupled to a first and a second host. If it is determined that the tape drive needs to be fenced a fence command is sent by a first host. The tape drive receives the fence command and in response fences the tape drive. If a second host sends a command that requires tape movement the tape drive returns a message to the second host informing the second host of a fenced status of the fenced tape drive. Further, the fenced state may be stored in non-volatile memory, thus, the fenced state remains and is persistent when the tape drive is power cycled.

### TECHNICAL FIELD

The present invention relates generally to the field of tape drives and, in particular, to a method, a system and computer program product for fencing a tape drive.

### BACKGROUND OF THE INVENTION

Automated data storage libraries provide convenient and low cost means for storing data. The data in automated data storage libraries is stored on storage media that are stored on storage shelves or the like inside the library. In addition to data storage media, automated data storage libraries typically contain data storage drives that store data to, and/or retrieve data from the data storage media in read and/or write processes. The data contained on the data storage media is typically valuable data (e.g. personal data, financial data, business data, etc.) and the reliability of the read and/or write processes is very important.

One limitation of existing data storage libraries is the inability of the host to fence a data storage drive that is working outside of its normal threshold from all hosts connected to the data storage library. As used herein, to fence a data storage drive generally means to prevent the data storage drive from performing any commands that require tape movement, including, for example, read commands, and write commands. If the drive is not fenced to prevent access from all hosts, another host may issue a command to the drive that requires tape movement, such as a read and/or write commands. If commands that require tape movement, such a read and/or write commands, are performed by the drive they could be unreliable, jeopardizing valuable data.

Moreover, another problem with known fencing techniques is that a fence created at the host level is not recognized by all hosts connected to the data storage library.

Finally, in known fencing techniques the fenced state was stored in volatile memory and thus the fenced state could be erased with a power cycle (turning the electrical power off to the drive and then restoring the electrical power). Therefore, it is possible for an operator who does not understand the cause of the fence to power cycle the data storage drive, and thus remove the fenced state. The newly unfenced drive in question would be available for performing commands that require tape movement, such as reading and/or writing, possibly jeopardizing valuable data.

### SUMMARY OF THE INVENTION

It has been discovered that by providing a fence at the drive level the fence is understood by all hosts that are interconnected with the tape drive despite the fact that the hosts may use different software, have a different platform, or utilize a different language. Therefore, the fenced drive is prevented from performing commands from all hosts that require tape movement, such as reading and/or writing, thus protecting the valuable data. Accordingly, one embodiment of the present invention provides a system, a method, and a computer program product. The tape drive is coupled to a first and a second host. If it is determined that the tape drive needs to be fenced, because, for example, the tape drive is operating outside of its normal parameters, a fence command is sent by a first host. The tape drive receives the fence command, and in response, fences the tape drive. If a second host sends a command for the tape drive that requires tape movement, the tape drive returns a message to the second host informing the second host of a fenced status of the fenced tape drive. Moreover, the fenced state may be stored in non-volatile memory, thus, the fenced state remains and is persistent when the tape drive is power cycled.

The host may determine that the tape drive is working outside of its normal threshold and that the tape drive needs to be fenced by monitoring or checking at least one parameter by one of: a health status inquiry of the tape drive, a query of the tape drive, an error status return of the tape drive, or a update of status of the tape drive at a mount or a demount. The parameters that may be monitored or checked include the time the tape drive takes to complete a command request, the age of the tape drive, the number of hours the tape drive has been operating, the temperature within the tape drive, a number of errors the tape drive has returned, the humidity within the tape drive, the number of time-outs of the tape drive, or a lack of motion within the drive. The parameters and the ranges of each parameter may be defined by the customer.

For a more detailed understanding of the disclosed invention, reference may be made to the following detailed description taken in conjunction with the accompanying drawings.

### BRIEF DESCRIPTION OF THE DRAWINGS

FIG. 1 is a block diagram illustrating a data storage library comprising two hosts;

FIG. 2 is a block diagram illustrating a data storage library coupled to a plurality of hosts;

FIG. 3 is a flow chart illustrating a method of fencing in accordance with one embodiment of the present invention;

FIG. 4 is a flow chart illustrating a method of fencing in accordance with another embodiment the present invention;

FIG. 5 is a block diagram illustrating a system in which certain embodiments are implemented.

### DETAILED DESCRIPTION OF THE PREFERRED EMBODIMENTS

The following is intended to provide a detailed description of an example of the invention and should not be taken to be limiting of the invention itself. Rather, any number of variations may fall within the scope of the invention which is defined in the claims following the description.

### Introduction

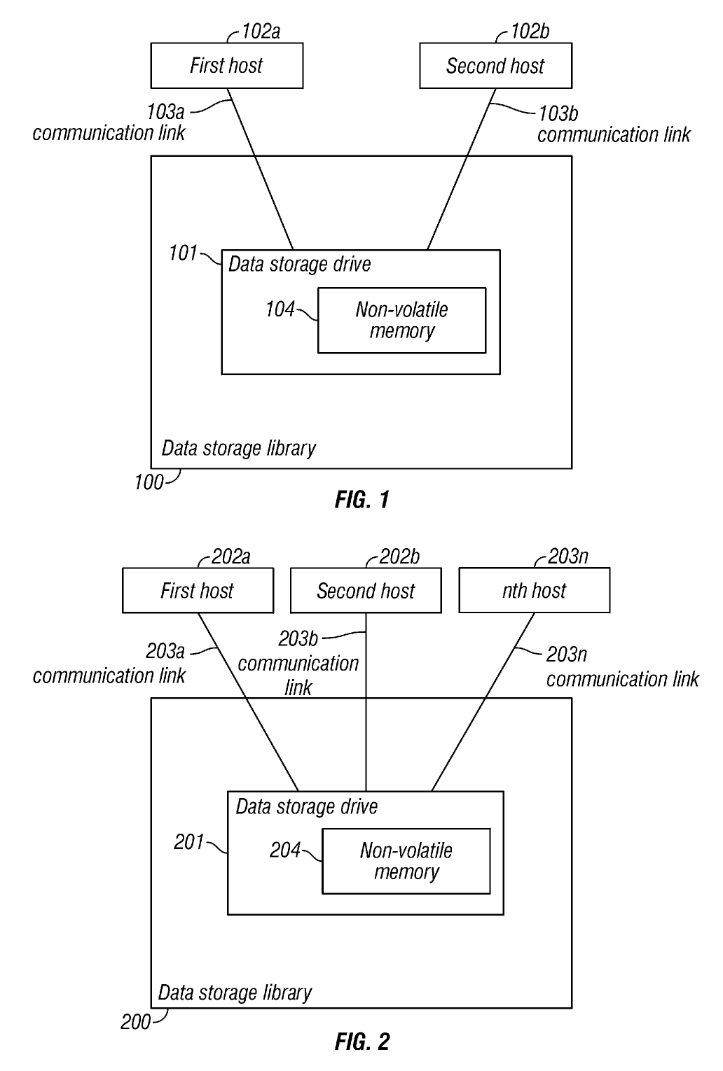

FIG. 1 illustrates an embodiment of a data storage library 100. Data storage library 100 contains data storage media (not shown) which are stored in storage shelves (not shown) or the like inside of the data storage library 100 in a fashion that allows the media, and the data on the media to be accessible for physical retrieval and tape movement operations such as read and/or write operations. Data storage media may comprise any type of media on which data may be stored and which may serve as removable media, including, but not limited to magnetic media (such as magnetic tape or disks), optical media (such as optical tape or disks), electronic media (such as PROM, EEPROM, flash PROM, MRAM, MEMS based storage, Compactflash™, Smartmedia™, Memory Stick™, etc.), or other suitable media. Typically, the data stored in the data storage library 100 on the data storage media is contained within a cartridge and referred to as a data storage media cartridge. An example of data storage media cartridge that is widely employed in automated data storage libraries for mass data storage is a magnetic tape cartridge.

The data storage library 100 includes one or more data storage drives, which comprises one data storage drive 101 in the illustrated example. The data storage drive conducts commands that require tape movement, including read and/or write operations, with data storage media cartridges in the library 100. The data storage drive 101 may be a magnetic tape drive, or an optical disk drive, or another type of data storage drive as are used to read and/or write data with respect to the data storage media.

The data storage drive 101 is coupled to one or more hosts, including a first host 102a, and a second host 102b in the illustrated example. The first host 102a and the second host 102b supply data to the data storage library 100 for storage on the cartridges, and send requests to the library 100 to retrieve data from the cartridges. The host systems such as host servers may communicate with the data storage drives directly, (e.g. on communication links 103a and 103b), or through the data storage library 100. Through these communication links, first host 102a and the second host 102b can provide commands to access particular data storage media, perform read and/or write commands or to move the media. Communication links 103a and 103b may be a serial interconnection, such as an RS-232 cable or an RS-432 cable, or Ethernet interconnection, a SCSI interconnection, a Fibre Channel interconnection, or ESCON interconnection, a FICON interconnection, a Local Area Network (LAN), a private Wide Area Network (WAN), a public wide area network, Storage Area Network (SAN), Transmission Control Protocol/Internet Protocol (TCP/IP), the Internet, and/or combinations thereof.

The first host 102a and/or the second host 102b may be a computer system, such as a mainframe, personal computer, workstation, etc., including an operating system such as Windows®, AIX®, Unix®, MVS™ etc. The first host 102a and/or the second host 102b may also be coupled to an interface and a host catalog (not shown). The interface enables the first host 102a and/or the second host 102b to exchange information of with a human operator, and may comprise a control panel, video monitor, computer keyboard/mouse, or another appropriate human/machine interface.

The first host 102a and the second host 102b manage data in the data storage library 100 using “location-centric” commands and may utilize the small computer system interface (“SCSI”) medium changer protocol as one example.

The data storage drive 100 also comprises one or more non-volatile memory 104 such an NVRAM, EEPROM, EPROM, PROM, FRAM, MRAM, flash memory, or bubble memory that is capable of storing commands issued from the host 102a and/or the second host 102b.

FIG. 2 illustrates an embodiment of a data storage library 200 with a plurality of hosts 202a, 202b . . . 202n. Data storage library 200 contains data storage media (not shown) which are stored in storage shelves (not shown) or the like inside of the data storage library 200 in a fashion that allows the media, and the data on the media to be accessible for physical retrieval and tape movement operations such as read and/or write operations. Data storage media may comprise any type of media on which data may be stored and which may serve as removable media, including, but not limited to magnetic media (such as magnetic tape or disks), optical media (such as optical tape or disks), electronic media (such as PROM, EEPROM, flash PROM, MRAM, MEMS based storage, Compactflash™, Smartmedia™, Memory Stick™, etc.), or other suitable media. Typically, the data stored in the data storage library 200 on the data storage media is contained within a cartridge and referred to as a data storage media cartridge. An example of data storage media cartridge that is widely employed in automated data storage libraries for mass data storage is a magnetic tape cartridge.

The data storage library 200 includes one or more data storage drives, which comprises one data storage drive 201 in the illustrated example. The data storage drive conducts commands that require tape movement, including read and/or write operations, with data storage media cartridges in the library 200. The data storage drive 201 may be a magnetic tape drive, or an optical disk drive, or another type of data storage drive as are used to read and/or write data with respect to the data storage media.

The data storage drives 201 are coupled to a plurality of hosts 202a, 202b . . . , 202n through data storage library 200. The plurality of hosts 202a, 202b . . . , 202n supply data to the data storage library 200 for storage on the cartridges, and send requests to the library 200 to retrieve data from the cartridges. The host systems such as host servers may communicate with the data storage drives directly, (e.g. on communication links 203a, 203b, . . . 203n), or through the data storage library 200. Through these communication links the plurality of hosts 202a, 202b . . . , 202n can provide commands to access particular data storage media, perform read and/or write commands or to move the media. Communication links 203a, 203b . . . , 203n comprises a serial interconnection, such as an RS-232 cable or an RS-432 cable, and Ethernet interconnection, a SCSI interconnection, a Fibre Channel interconnection, and ESCON interconnection, a FICON interconnection, a Local Area Network (LAN), a private Wide Area Network (WAN), a public wide area network, Storage Area Network (SAN), Transmission Control Protocol/Internet Protocol (TCP/IP), the Internet, and combinations thereof.

It will be noted that the variable identifier “n” is used in several instances in FIG. 1 to more simply designate the final element (e.g., plurality of hosts 202a, 202b, . . . 202n and communication links 203a, 203b, . . . 203n) of a series of related or similar elements (e.g., hosts and communication links). The repeated use of such variable identifiers is not meant to imply a correlation between the sizes of such series of elements, although such correlation may exist. The use of such variable identifiers does not require that each series of elements has the same number of elements as another series delimited by the same variable identifier. Rather, in each instance of use, the variable identified by “n” may hold the same or a different value than other instances of the same variable identifier.

The plurality of hosts 202a, 202b . . . , 202n may be a computer system, such as a mainframe, personal computer, workstation, etc., including an operating system such as Windows®, AIX®, Unix®, MVS™ etc. The plurality of hosts 202a, 202b . . . , 202n may also be coupled to an interface and a host catalog (not shown). The interface enables the plurality of hosts 202a, 202b . . . , 202n to exchange information of with a human operator, and may comprise a control panel, video monitor, computer keyboard/mouse, or another appropriate human/machine interface.

The plurality of hosts 202a, 202b . . . , 202n manage data in the data storage library 200 using “location-centric” commands and may utilize the small computer system interface (“SCSI”) medium changer protocol as one example.

### Operation

One embodiment of the present invention is described as embodied in a magnetic tape storage system for use in a data processing environment. However, one skilled in the art will recognize the invention equally applies to optical disk cartridges or other removable storage media and the use of either different types of cartridges or cartridges of the same type having different characteristics. Furthermore, the description of a magnetic tape storage system is not meant to limit the invention to magnetic tape data processing application as the invention herein can be applied to any media storage and cartridge systems in general.

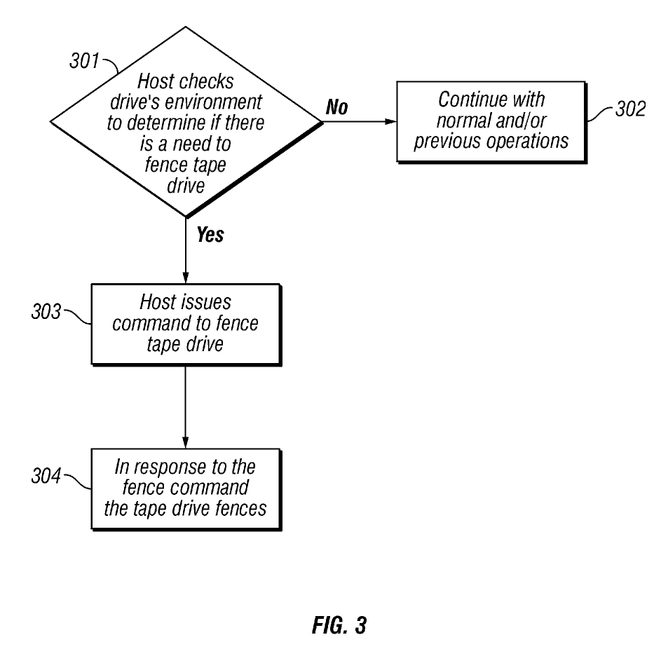

FIG. 3 is a flowchart illustrating the steps to implement an embodiment of the present invention. In step 301, the first or the second host 102a, 102b (for the purpose of this example first host 102a) checks the environment or operation of data storage drive 101 (e.g. tape drive, hereinafter referred to as tape drive 101) to determine the drive is operating outside of its normal threshold and if there is a need to fence the tape drive.

The tape drive 101 may have certain operation parameters with predefined ranges for each parameter. In one embodiment of the present invention the customer can determine the parameters that are to be monitored or checked. Moreover, the customer can define a predetermined range for each parameter. Optionally, in another embodiment of the present invention the parameters and the predetermined ranges for the parameters may be defined by the manufacturer of the tape drive 101. In yet another embodiment, both options may be present. When the tape drive 101 is operating outside of the predetermined range for one or more parameters then the tape drive is said to be operating outside of its normal threshold.

The first or the second host 102a, 102b may check or monitor the environment of the tape drive 101 in a number of ways to determine if the drive is operating outside of its normal threshold. For example, the host (for example 102a) may check or monitor the drive and subsequently determine whether the drive is operating within normal threshold by requesting a health status inquiry from the tape drive 101, querying the tape drive 101, or by a set update of the status of the tape drive 101 at mount or demount time.

The possible parameters that may be monitored when checking the environment of the tape drive 101 include the time to complete a command, the age of the drive, the temperature of the drive, the number of errors the drive has returned, the humidity within the drive, presence of excessive time-outs, the lack of motion within the drive, etc.

For example, one indication of that the tape drive 101 may need to be fenced is the failure of the tape drive 101 to properly perform a command issued by one of the first or second hosts 102a, 102b. In this case an error status may be returned to the host 102a indicating that the command has failed. If the host 102a determines that the error is severe enough (e.g. the tape cartridge is jammed in the tape drive 101, the tape is loose on the reel, or the tape has broken) or that the tape drive 101 has exceeded a number of errors beyond the customer defined predetermined range the host 102a may determine that the tape drive 101 needs to be fenced.

As mentioned above, the customer can define a predetermined range for each parameter. For example, one customer may determine that the tape drive 101 should be fenced when the tape drive 101 returns more than 1 servo error, while another customer may determine that tape drive 101 should be fenced when tape drive 101 returns more than 10 servo errors. Similarly, the customer may determine that the tape drive 101 needs to be fenced when the tape drive exceeds the customer defined time-outs. In one example, the customer may choose to fence after 100 time-outs.

The customer may also define a predetermined number of operating hours the tape drive 101 may operate or an age of the tape drive at which the tape drive should be fenced. For example the customer may determine after 1000 hours of operation or after 6 months of age that the tape drive 101 should be fenced. In addition, the customer may also determine to fence the tape drive based on the time that the tape drive takes to complete a command request. For example a customer may determine that a tape drive taking more than 60 minutes should be fenced. Moreover, the customer may define a predetermined operating temperature of the tape drive 101. For example, the customer may determine that if the temperature deviates more then 3% from the defined 43.0 degree Celsius the tape drive 101 should be fenced. In another example, the customer may define a predetermined operating humidity within the tape drive 101. For example, the customer may determine that above 25% the tape drive 101 should be fenced.

By allowing the customer to independently define and configure the threshold for fencing, the customer can adjust the settings based on their own tolerances for possible unreliable data. It is noted that the above defined predetermined ranges are merely exemplary and may be defined by each individual customer to suit their individual needs.

In step 302 if the tape drive 101 is operating within its normal threshold and it is determined that the there is no need to fence the tape drive 101 then the tape drive 101 continues with normal operations and/or the operations that the tape drive 101 was previously performing before the check in step 301.

In step 303, if the host (for example the first host 102a) determines that the tape drive 101, needs to be fenced, the first host 102a issues a command to fence the tape drive 101 as seen in step 303. The fence command may be accomplished by a mode select command or a send diagnostic command, or any other appropriate command that can create a setting on the drive as understood by one of ordinary skill in the art. The tape drive 101 receives the command to fence, and in step 304, in response to the host issued command to fence the tape drive 101 fences. As used herein, to fence a data storage drive (e.g. tape drive) generally means to prevent the data storage drive from performing any commands that require tape movement. In one embodiment of the present invention, tape drive 101 fences in accordance with standard SCSI protocol. Once the tape drive 101 is fenced it is unable to perform any commands that require tape movement that are issued not only by the host that issued the fence command (for example first host 102a), but also by all other hosts connected to the tape drive 101 by the communication links 103a and 103b (for example second host 102b).

It is important to note that the tape drive 101 is still connected by communication links 103 and 103b to the first and second hosts 102a and 102b, and as such, the tape drive 101 still may provide health status data upon an inquiry of at least one of first and second hosts 102a and 102b, as well as other commands that do not require tape movement issued by at least one of first and second hosts 102a and 102b.

Each of the blocks of the flow diagram of FIG. 3, and those depicted in subsequent figures, may be executed by a module (e.g., a software module) or a portion of a module or a computer system user. The methods described herein, the operations thereof and modules for performing such methods may therefore be executed on a computer system configured to execute the operations of the method and/or may be executed from computer-readable media. The method may be embodied in a machine-readable and/or computer-readable medium for configuring a computer system to execute the method. The software modules may be stored within and/or transmitted to a computer system memory to configure the computer system to perform the functions of the module. Alternatively, such actions may be embodied in the structure of circuitry that implements such functionality, such as the micro-code of a complex instruction set computer (CISC), firmware programmed into programmable or erasable/programmable devices, the configuration of a field-programmable gate array (FPGA), the design of a gate array or full-custom application-specific integrated circuit (ASIC), or the like.

Those skilled in the art will also recognize that the boundaries between modules and operations depicted herein are merely illustrative and alternative embodiments may merge such modules or operations, or impose an alternative decomposition of functionality thereon. For example, the actions discussed herein may be decomposed into sub-operations to be executed as multiple computer processes. Moreover, alternative embodiments may combine multiple instances of a particular operation or sub-operation. Furthermore, those skilled in the art will recognize that the operations described in exemplary embodiment are for illustration only. Operations may be combined or the functionality of the operations may be distributed in additional operations in accordance with the invention. As will also be apparent to those of skill in the art, methods for determining delay and jitter described herein may employ other techniques (similar in effect to those described herein) to make such determinations, and such alternative techniques are intended to be comprehended by the methods and apparati discussed herein.

In one aspect of the invention the command to fence is stored in non-volatile memory such an NVRAM, EEPROM, EPROM, PROM, FRAM, MRAM, flash memory, or bubble memory within tape drive 101. Therefore, when power to the drive is lost in some way, for example power-cycled, the fenced state is retained in the non-volatile memory 104, thus, the fenced state remains and is persistent when the tape drive is power cycled. This aspect of the invention prevents an operator or someone without knowledge or understanding of the reason the drive is fenced to power cycle the drive and thus remove the fence. As known by one skilled in the art a power cycle comprises turning the electrical power off to the drive and then restoring the electrical power.

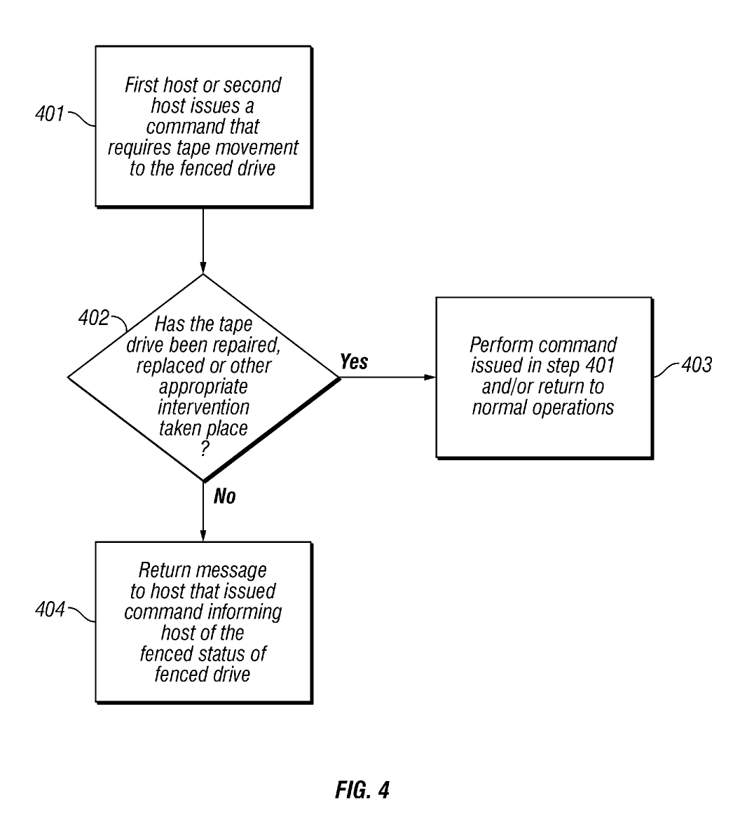

In step 401 shown in FIG. 4, the first host 102a or the second host 102b issue a command that requires tape movement to the fenced tape drive 101 which was fenced by the method shown in FIG. 3.

In step 402 the tape drive 101 may be repaired or replaced or other appropriate intervention may have taken place. If the tape drive 101 has been repaired or replaced or some other appropriate invention has taken place in step 402 then the tape drive 101 receives the command and performs the issued command and/or return to normal operations as seen in step 403. It is advantageous for the tape drive 101 to be repaired or replaced or some other appropriate intervention to take place immediately so that the valuable resources of the tape drive 101 can be placed online and operational. However, it is not always possible to repair or replace or perform some other appropriate intervention on the fenced tape drive 101 immediately.

In the case where the tape drive 101 has not been repaired or replaced, or there has been no other appropriate intervention in step 402, the tape drive 101 receives the issued command in step 401. As seen in step 404, in response to the command issued in step 401 the tape drive returns a message to the host that issued the command (for example 102a) informing the host of the status of the fenced tape drive.

The fenced tape drive 101 continues to be fenced and return a message informing the host that sends the commands that require tape movement of the fenced status until the tape drive 101 is repaired or replaced, or there has been some other appropriate intervention. The fence remains permanent and understood by all hosts in this manner until the tape drive 101 is repaired or replaced, or there has been some other appropriate intervention.

While it has been explained in the present embodiment that all of the hosts have the same capability and all oversee the drive, in another embodiment, there could be a more intelligent host that oversees the drives and other host dedicated to perform the everyday storage processes or reads and/or writes.

While FIG. 3 and FIG. 4 were described with respect to fencing a data storage drive 101 in a data storage library 100 with a first and a second host 102a, 102b (as seen in FIG. 1) those skilled in the art will recognize that many modifications may be made without departing from the scope of embodiments, and that the process of FIGS. 3 and 4 may be applied to the data storage library containing a plurality of hosts 102a, 102b, . . . 102n (as seen in FIG. 2).

Further, while the above embodiments were described with respect to a data storage library, one of ordinary skill in the art will understand that the data storage drive 101 could be outside of a library and be a stand-alone drive that is connected to one or more hosts.

### Additional Embodiment Details

The described techniques may be implemented as a method, system or article of manufacture involving software, firmware, micro-code, hardware and/or any combination thereof. The term “article of manufacture” as used herein refers to code or logic implemented in a medium, where such medium may comprise hardware logic [e.g., an integrated circuit chip, Programmable Gate Array (PGA), Application Specific Integrated Circuit (ASIC), etc.] or a computer readable medium, such as magnetic storage medium (e.g., hard disk drives, floppy disks, tape, etc.), optical storage (CD-ROMs, optical disks, etc.), volatile and non-volatile memory devices [e.g., Electrically Erasable Programmable Read Only Memory (EEPROM), Read Only Memory (ROM), Programmable Read Only Memory (PROM), Random Access Memory (RAM), Dynamic Random Access Memory (DRAM), Static Random Access Memory (SRAM), flash, firmware, programmable logic, etc.]. Code in the computer readable medium is accessed and executed by a processor. The medium in which the code or logic is encoded may also comprise transmission signals propagating through space or a transmission media, such as an optical fiber, copper wire, etc. The transmission signal in which the code or logic is encoded may further comprise a wireless signal, satellite transmission, radio waves, infrared signals, Bluetooth, etc. The transmission signal in which the code or logic is encoded is capable of being transmitted by a transmitting station and received by a receiving station, where the code or logic encoded in the transmission signal may be decoded and stored in hardware or a computer readable medium at the receiving and transmitting stations or devices. Additionally, the “article of manufacture” may comprise a combination of hardware and software components in which the code is embodied, processed, and executed. Of course, those skilled in the art will recognize that many modifications may be made without departing from the scope of embodiments, and that the article of manufacture may comprise any information bearing medium. For example, the article of manufacture comprises a storage medium having stored therein instructions that when executed by a machine results in operations being performed.

Certain embodiments can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, certain embodiments can take the form of a computer program product accessible from a computer usable or computer readable medium providing program code for use by or in connection with a computer or any instruction execution system. For the purposes of this description, a computer usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

The terms “certain embodiments”, “an embodiment”, “embodiment”, “embodiments”, “the embodiment”, “the embodiments”, “one or more embodiments”, “some embodiments”, and “one embodiment” mean one or more (but not all) embodiments unless expressly specified otherwise. The terms “including”, “comprising”, “having” and variations thereof mean “including but not limited to”, unless expressly specified otherwise. The enumerated listing of items does not imply that any or all of the items are mutually exclusive, unless expressly specified otherwise. The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries. Additionally, a description of an embodiment with several components in communication with each other does not imply that all such components are required. On the contrary a variety of optional components are described to illustrate the wide variety of possible embodiments.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously, in parallel, or concurrently.

When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article. The functionality and/or the features of a device may be alternatively embodied by one or more other devices which are not explicitly described as having such functionality/features. Thus, other embodiments need not include the device itself.

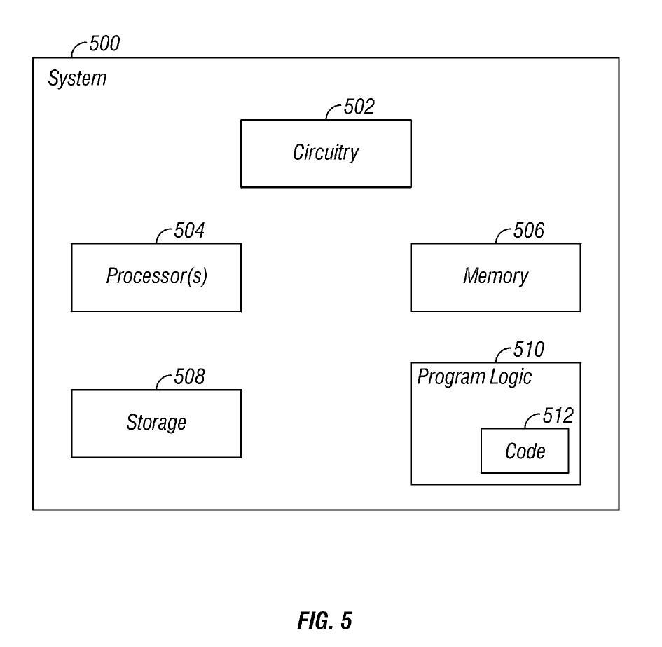

FIG. 5 illustrates a block diagram of a system 500 in which certain embodiments may be implemented. In certain embodiments, processing components such as the hosts 102a, 102b, . . . 102n may be implemented in accordance with the system 500. The system 500 may include circuitry 502 that may in certain embodiments include a processor 504. The system 500 may also include a memory 506 (e.g., a volatile memory device), and storage 508. Certain elements of the system 500 may or may not be found in the processing components such as the hosts 102a, 102b, . . . 102n. The storage 508 may include a non-volatile memory device (e.g., EEPROM, ROM, PROM, RAM, DRAM, SRAM, flash, firmware, programmable logic, etc.), magnetic disk drive, optical disk drive, tape drive, etc. The storage 508 may comprise an internal storage device, an attached storage device and/or a network accessible storage device. The system 500 may include a program logic 510 including code 512 that may be loaded into the memory 506 and executed by the processor 504 or circuitry 502. In certain embodiments, the program logic 510 including code 512 may be stored in the storage 508. In certain other embodiments, the program logic 510 may be implemented in the circuitry 502. Therefore, while FIG. 5 shows the program logic 510 separately from the other elements, the program logic 510 may be implemented in the memory 506 and/or the circuitry 502.

Certain embodiments may be directed to a method for deploying computing instruction by a person or automated processing integrating computer-readable code into a computing system, wherein the code in combination with the computing system is enabled to perform the operations of the described embodiments.

At least certain of the operations illustrated in FIGS. 3 and 4 may be performed in parallel as well as sequentially. In alternative embodiments, certain of the operations may be performed in a different order, modified or removed.

Furthermore, many of the software and hardware components have been described in separate modules for purposes of illustration. Such components may be integrated into a fewer number of components or divided into a larger number of components. Additionally, certain operations described as performed by a specific component may be performed by other components.

The data structures and components shown or referred to in FIGS. 1-5 are described as having specific types of information. In alternative embodiments, the data structures and components may be structured differently and have fewer, more or different fields or different functions than those shown or referred to in the figures. Therefore, the foregoing description of the embodiments has been presented for the purposes of illustration and description. It is not intended to be exhaustive or to limit the embodiments to the precise form disclosed. Many modifications and variations are possible in light of the above teaching.

The present invention allows for a method to fence a storage drive that overcomes the disadvantages of the prior art. The method provides a fence of a tape drive at the tape drive level such that the fence is understood by all hosts that are interconnected with the tape drive despite the fact that the hosts may use different software, have a different platform, or utilize a different language. Therefore, this method provides that advantage that the fenced drive is prevented from performing any commands that require tape movement, such as read and/or write requests, from all hosts, thus protecting the valuable data. Further, the method of the present invention prevents the fence from being removed from the drive in a power cycle of the drive so that the fence is permanent. Finally, while traditionally only the tape drive manufacturers or vendors had the ability to fence a tape drive, the present invention gives the customers the ability to fence the tape drive, and to determine, according to their needs, when to fence the tape drive.

While particular embodiments of the present invention have been shown and described, it will be obvious to those skilled in the art that, based upon the teachings herein changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims.

What is claimed is:

1. A method of fencing a tape drive, said tape drive coupled to a first host and a second host, the method comprising said tape drive:
receiving a fence command from said first host;
receiving a command that requires tape movement from said second host; and
in response to receiving said command that requires tape movement from said second host sending a message to said second host informing said second host of a fenced status of said fenced tape drive.

2. The method of fencing claim 1, further comprising said tape drive:
storing said fenced status in a non-volatile memory.

3. The method of claim 2, wherein said non-volatile memory is any one of a NVRAM, EEPROM, EPROM, PROM, FRAM, MRAM, flash memory, or bubble memory.

4. The method of claim 1, wherein said command that requires tape movement is one of a read command and a write command.

5. The method of claim 1, further comprising:
determining if said tape drive needs to be fenced.

6. The method of claim 5, wherein said determining is accomplished by obtaining at least one parameter by one of a health status inquiry of said tape drive, a query of said tape drive, an error status return of said tape drive, or an update of a status of said tape drive at a mount or a demount.

7. The method of claim 6, wherein said at least one parameter is one of a time said tape drive takes to complete a command request, an age of said tape drive, a number of hours said tape drive has been operating, a temperature within said tape drive, a number of errors said tape drive has returned, a humidity within said tape drive, a number of time-outs of said tape drive, a lack of motion within said tape drive.

8. The method of claim 6, wherein said at least one parameter is a customer defined parameter.

9. A system for fencing a tape drive comprising:
a tape drive configured to be coupled to a first host and a second host;
said tape drive configured to receive a fence command from said first host;
said tape drive configured to receive a command that requires tape movement from said second host;
in response to receiving said command that requires tape movement from said second host said tape drive configured to inform said second host of a fenced status of said fenced tape drive.

10. The system of claim 9, further comprising:
said tape drive configured to store said fenced status in a non-volatile memory.

11. The system of claim 10, wherein said non-volatile memory is any one of a NVRAM, EEPROM, EPROM, PROM, FRAM, MRAM, flash memory, or bubble memory.

12. The system of claim 9, wherein said command that requires tape movement is one of a read command and a write command.

13. The system of claim 9, further comprising:
said first host configured to determine if said tape drive needs to be fenced.

14. The system of claim 13, wherein said tape drive is configured to:
perform said determining by obtaining at least one parameter by one of a health status inquiry of said tape drive, a query of said tape drive, an error status return of said tape drive, or an update of a status of said tape drive at a mount or a demount.

15. The system of claim 14, wherein said at least one parameter is one of a time said tape drive takes to complete a command request, an age of said tape drive, a number of hours said tape drive has been operating, a temperature within said tape drive, a number of errors said tape drive has returned, a humidity within said tape drive, a number of time-outs of said tape drive, a lack of motion within said tape drive.

16. The system of claim 14, wherein said at least one parameter is a customer defined parameter.

17. A computer program product comprising a machine-readable medium including machine executable instructions therein for a method of fencing a tape drive, said tape drive coupled to a first host and a second host, comprising the steps of said tape drive:
receiving a fence command from said first host;
receiving a command that requires tape movement from said second host;
in response to receiving said command that requires tape movement from said second host sending a message to said second host informing said second host of a fenced status of said fenced tape drive.

18. The computer program product of claim 17, further comprising:
storing said fenced status in a non-volatile memory.

19. The computer program product of claim 18, wherein said non-volatile memory is any one of a NVRAM, EEPROM, EPROM, PROM, FRAM, MRAM, flash memory, or bubble memory.

20. The computer program product of claim 17, wherein said command that requires tape movement is one of a read command and a write command.

21. The computer program product of claim 17, further comprising:
determining if said tape drive needs to be fenced.

22. The computer program product of claim 21, wherein said determining is accomplished by obtaining at least one parameter by one of a health status inquiry of said tape drive, a query of said tape drive, an error status return of said tape drive, or an update of a status of said tape drive at a mount or a demount.

23. The computer program product of claim 22, wherein said at least one parameter is one of a time said tape drive takes to complete a command request, an age of said tape drive, a number of hours said tape drive has been operating, a temperature within said tape drive, a number of errors said tape drive has returned, a humidity within said tape drive, a number of time-outs of said tape drive, a lack of motion within said tape drive.

24. The computer program product of claim 22, wherein said at least one parameter is a customer defined parameter.

25. A method of fencing a tape drive, said tape drive coupled to at least one host, the method comprising said tape drive:
receiving a fence command from said first host;
in response to receiving a fence command from said first host, storing a fenced status in a non-volatile memory;
receiving a command that requires tape movement from said at least one host; and
in response to receiving said command that requires tape movement from said at least one host sending a message to said at least one host informing said at least one host of a fenced status of said fenced tape drive.

26. The method of claim 25, wherein said fenced status is persistent after said tape drive is power cycled.

27. The method of claim 25, wherein said non-volatile memory is any one of a NVRAM, EEPROM, EPROM, PROM, FRAM, MRAM, flash memory, or bubble memory.

28. A system for fencing a tape drive comprising:
a tape drive configured to be coupled to at least one host;
said tape drive configured to receive a fence command from said first host;
in response to said fence command, said tape drive configured to store a fenced status in a non-volatile memory;
said tape drive configured to receive a command that requires tape movement from said at least one host; and
in response to receiving said command that requires tape movement from said at least one host said tape drive configured to send a message to said at least one host informing said at least one host of a fenced status of said fenced tape drive.

29. The system of claim 28, wherein said tape drive is configured to store said fenced status in non-volatile memory such that said fenced status is persistent after said tape drive is power cycled.

30. The system of claim 28, wherein said non-volatile memory is any one of a NVRAM, EEPROM, EPROM, PROM, FRAM, MRAM, flash memory, or bubble memory.

31. A computer program product comprising a machine-readable medium including machine executable instructions therein for a method of fencing a tape drive, said tape drive coupled to a first host and a second host, comprising the steps of said tape drive:
receiving a fence command from said first host;
in response to receiving a fence command form said first host, storing a fenced status in a non-volatile memory;
receiving a command that requires tape movement from said at least one host; and
in response to receiving said command that requires tape movement from said at least one host sending a message to said at least one host informing said at least one host of a fenced status of said fenced tape drive.

32. The computer program product of claim 31, wherein said fenced status is persistent after said tape drive is power cycled.

33. The computer program product of claim 31, wherein said non-volatile memory is any one of a NVRAM, EEPROM, EPROM, PROM, FRAM, MRAM, flash memory, or bubble memory.
